(19) United States
(12) Patent Application Publication
(10) Pub. No.: US 2009/0061830 A1
(43) Pub. Date: Mar. 5, 2009

(54) SYSTEM AND METHOD FOR REQUESTING ASYNCHRONOUS FILE DOWNLOADS TO A CELLULAR PERVASIVE DEVICE FROM A WEBSITE

(76) Inventor: Robert R. Peterson, Austin, TX (US)

Correspondence Address: HOFFMAN WARNICK LLC, 75 STATE ST, 14TH FLOOR, ALBANY, NY, 12207, US

(21) Appl. No.: 11/848,267

(22) Filed: Aug. 31, 2007

(51) Int. Cl. H04Q 7/22; H04Q 7/00

(52) U.S. Cl. 455/414.1; 370/310.2

(57) ABSTRACT

The present invention is a system and method for requesting asynchronous file downloads to a cellular pervasive device from a website. Because cell phones have enough bandwidth and storage space to download the file and store the file, the present invention provides the ability to schedule asynchronous downloads to a cellular device that are automatically resumed after network disconnects and network changes from a website. The method allows a user, having a cellular pervasive device having connectivity to a website server, to request and receive asynchronous file downloads to his cellular pervasive device from a website server comprising the steps of the user logging into the website, the user entering a URL for a file download to his cellular pervasive device from the website; and the website server downloading a file to the user's cellular pervasive device.

### FIELD OF THE INVENTION

The present invention relates generally to cell phones and file downloads and, more specifically, to a system and method for requesting and receiving asynchronous file downloads to a cellular pervasive device from a website.

### BACKGROUND OF THE INVENTION

Customer support employees travel for a customer “critsits” (critical situations) for a software product. The customer support employees know that they have long flights ahead during which they want to be productive; thus, there is a goal to stage a software environment on the customer support employee's laptop prior to boarding the customer support employee's flight in order to try and replicate a customer's problem while in-flight. Due to meetings, packing, travel, etc., customer support employees have difficulty keeping Internet access long enough on to their laptops to download a very necessary large data files. Some customer support employees have tried a majority of the day from 8 AM to 3:30 PM to download the file, but they've keep having to disconnect in order to get to the office, move to another building for meeting, or get to the airport.

For instance, a user can have 90% of the file downloaded utilizing an airport's wireless system when the final boarding call is made for the first flight. The next layover is in a different airport where there is no WI-FI network. (Wi-Fi is a wireless technology brand owned by the Wi-Fi Alliance intended to improve the interoperability of wireless local area network products based on the IEEE 802.11 standards. Common applications for Wi-Fi include Internet and VoIP phone access, gaming, and network connectivity for consumer electronics such as televisions, DVD players, and digital cameras.) Thus, the fundamental problem is intermittent connectivity to broadband access. A limited solution to this problem today is to use a restartable download program such as: GetRight—http://www.getright.com IBM DownlodDirector—http://www.ibm.com/support/us/ddhelp.html

There presently is a need for a system and method for requesting asynchronous file downloads to a cellular pervasive device from a website.

### BRIEF SUMMARY OF THE INVENTION

The present invention is a system and method for requesting asynchronous file downloads to a cellular pervasive device from a website. Because cell phones have enough bandwidth and storage space to download the file and store the file, the present invention provides the ability to schedule asynchronous downloads to a cellular device that are automatically resumed after network disconnects and network changes from a website. Most business travelers have an unlimited data access service for either their cell phones or PDAs. Bandwidth for cellular devices is also increasing with the advent of so called 3G (third generation) wireless Internet networks such as EV-DO and EDGE. (Evolution-Data Optimized or Evolution-Data only, abbreviated as EV-DO or EVDO and often EV, is a telecommunications standard for the wireless transmission of data through radio signals, typically for broadband Internet access. It is classified as a broadband technology, because it uses a broad band of radio frequencies. It employs multiplexing techniques such as CDMA (Code division multiple access) as well as Frequency division duplex (FDD) to maximize the amount of data transmitted. It is standardized by 3rd Generation Partnership Project 2 (3GPP2) as part of the CDMA2000 family of standards and has been adopted by many mobile phone service providers around the world—particularly those previously employing CDMA networks (as opposed to GSM networks).

The illustrative aspects of the present invention are designed to solve one or more of the problems herein described and/or one or more other problems not discussed.

### BRIEF DESCRIPTION OF THE SEVERAL VIEWS OF THE DRAWINGS

These and other features of the invention will be more readily understood from the following detailed description of the various aspects of the invention taken in conjunction with the accompanying drawings that depict various embodiments of the invention, in which:

FIG. 1 depicts the present invention for requesting asynchronous file downloads to a cellular pervasive device from a website.

FIG. 2 illustrates a preferred embodiment of the method of the present invention.

FIG. 3 illustrates a further preferred embodiment of the method of the present invention.

FIG. 4 illustrates a preferred embodiment of the system of the present invention.

The drawings are intended to depict only typical aspects of the invention, and therefore should not be considered as limiting the scope of the invention. In the drawings, like numbering represent like elements between the drawings.

### DETAILED DESCRIPTION OF THE INVENTION

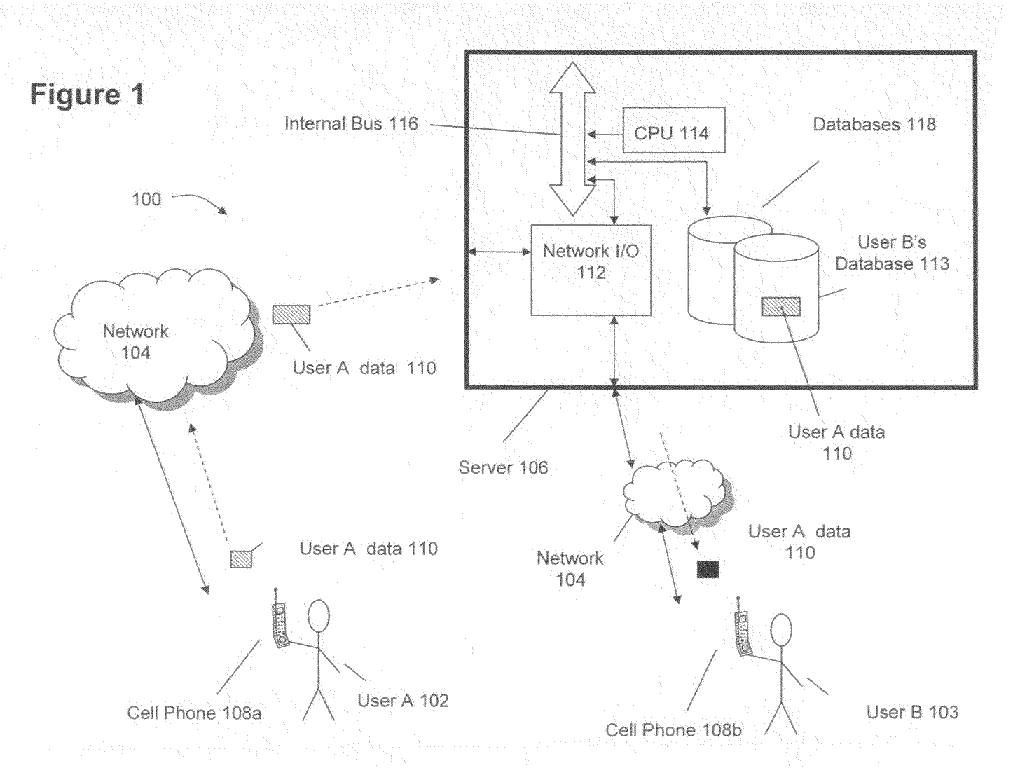

The present invention provides a system for requesting asynchronous file downloads to a cellular pervasive device from a website. This is shown in the system 100 in FIG. 1 where a first caller (User A 102) is sending a Data File 110 through a Network 104 to a second caller (User B 103) and uploads a file for User B 103 for storage in User B's storage area in Server 106. Of course, User A 102 may be using a personal computer (PC), a PDA (personal digital assistant) or some other like device or the file may be uploaded User B 103. The Network 104 comprises at least one Server 106 which has a CPU 114, a Network I/O 112, and Databases 118.

When User A 102 makes a phone call and uploads a file (such as Data File 110) to User B 103 and User B 103 doesn't accept the User A 102 call and Data File 110 within the predetermined number of rings or buzzes and cannot accept the User A 102 call and Data File 110, the Server 106 directs the User A 102 call and Data File 110 to User B's Database 113 so that User A 102 may leave a data message (User A Data 110) for User B 103. Of course, User B 103 can upload a data file (such as Data File 110) to her own Database 113 for a later download.

Cell phones have enough bandwidth and storage space to download the Data File 110 and store the Data File 110. The present invention provides the ability to schedule asynchronous downloads of data files (such as Data File 110) to a cellular device (such as Cell Phone 108b) which are automatically resumed after network disconnects and network changes from a website. Most business travelers have an unlimited data access service for either their cell phones (such as Cell Phone 108b) or PDAs. Bandwidth for cellular devices (such as Cell Phone 108b) is also increasing with the advent of so called 3G (third generation) wireless Internet networks such as EV-DO and EDGE. (Evolution-Data Optimized or Evolution-Data only, abbreviated as EV-DO or EVDO and often EV, is a telecommunications standard for the wireless transmission of data through radio signals, typically for broadband Internet access. It is classified as a broadband technology, because it uses a broad band of radio frequencies. It employs multiplexing techniques such as CDMA (Code division multiple access) as well as Frequency Division Duplex (FDD) to maximize the amount of data transmitted. It is standardized by 3rd Generation Partnership Project 2 (3GPP2) as part of the CDMA2000 family of standards and has been adopted by many mobile phone service providers around the world—particularly those previously employing CDMA networks (as opposed to GSM networks). The EV-DO feature of CDMA2000 networks is significantly faster than the Enhanced Data Rates for GSM Evolution (EDGE) used by GSM networks. It provides access to mobile devices with air interface speeds of up to 2.4 Mbit/s with Rev. 0 and up to 3.1 Mbit/s with Rev. A. High-Speed Downlink Packet Access (HSDPA), a competing technology for Wideband Code Division Multiple Access (W-CDMA), along with the new Qualcomm® Rev A modems have the ability to maintain both circuit switched voice and packet data calls from the same radio; this functionality is not available in Qualcomm Rev. 0 chipsets. It provides an IP based network. (Enhanced Data rates for GSM Evolution (EDGE) or Enhanced GPRS (EGPRS), is a digital mobile phone technology that allows it to increase data transmission rate and improve data transmission reliability. Although technically a 3G network technology, it is generally classified as the unofficial standard 2.75G, due to its slower network speed. EDGE was introduced into GSM networks around the world since 2003, initially in North America. It can be used for any packet switched application such as an Internet connection. (Global System for Mobile communications (GSM: originally from Groupe Spécial Mobile) is the most popular standard for mobile phones in the world. GSM service is used by over 2 billion people across more than 212 countries and territories. Its ubiquity makes international roaming very common between mobile phone operators, enabling subscribers to use their phones in many parts of the world. GSM differs significantly from its predecessors in that both signaling and speech channels are digital call quality, and so is considered a second generation (2G) mobile phone system. This has also meant that data communication was built into the system using the 3rd Generation Partnership Project (3GPP).) High-speed data applications such as video services and other multimedia benefit from EGPRS' increased data capacity. EDGE Circuit Switched is a possible future development. EDGE Evolution continues in Release 7 of the 3GPP standard providing doubled performance (e.g., to complement High-Speed Packet Access (HSPA)). There have been several revisions of the standard; named alphabetically starting with the first as Rev. A (“revision A”) while the first standard is referred to simply as Rev. 0.

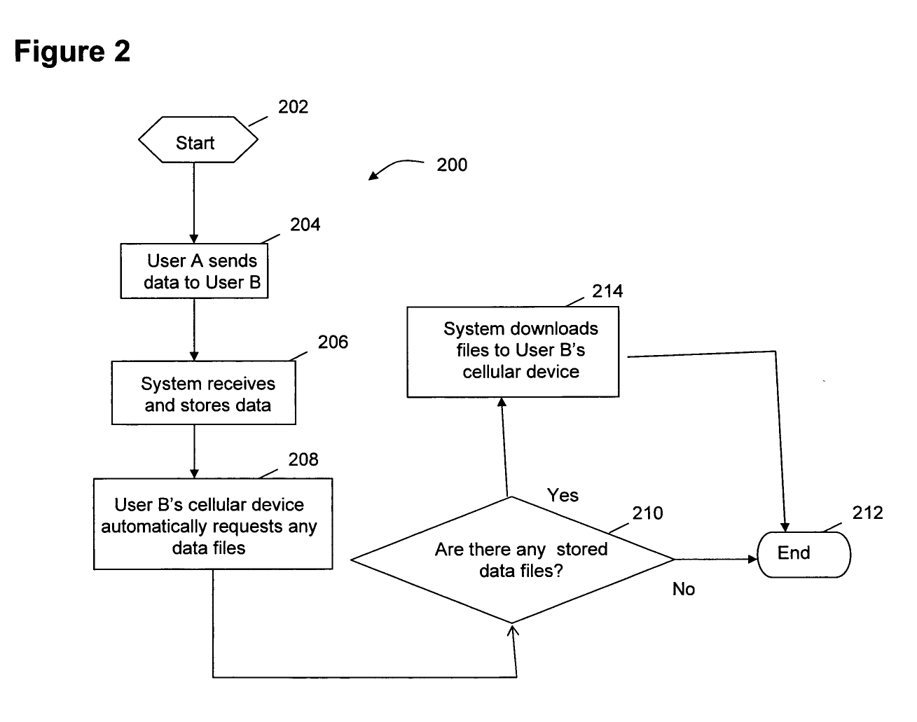

The method 200 of the present invention is shown in FIG. 2 which starts at step 202 and continues to 204 where User A sends data to User B. At 206, the system receives and stores the data. It should be noted User B may send the data to the system instead of User A. At 208, User B's cellular device automatically requests, from the system, for any data files. At 210, the system determines whether there are any stored data files and, if so, at 212, the system downloads the stored files to the cellular device of User B or, if not, the process ends at 212.

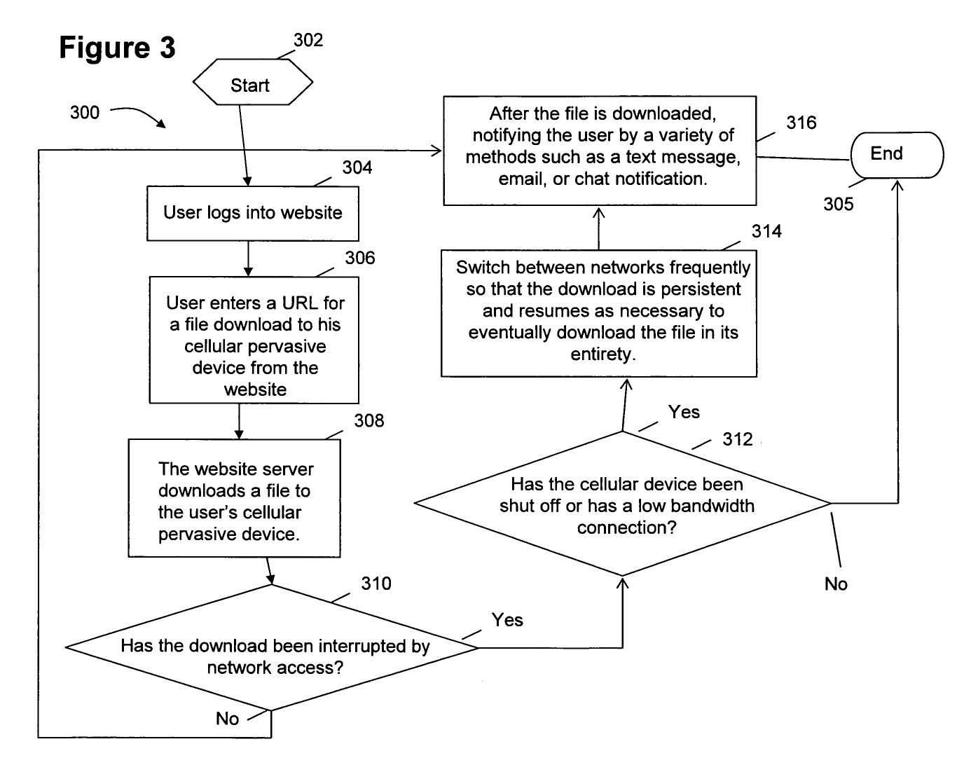

The method of the present invention (300 as shown in FIG. 3) starts at 302. The user utilizes a wireless service where the user logs into a website using his cell phone (PDA or, alternatively, other cellular pervasive devices) at 304, enters a URL for a file download at 306, and the server initiates the download of that file to the user's cell phone or PDA device at 308. Most importantly, the download is reliable and continuous even with interrupted network access by the device. For example, the system determines whether the download has been interrupted at 310. If the device does not have a signal when the user submits the website request, the initiation of the download is deferred by the server until the device has connectivity. This facilitates a reliable download of large files to the device with minimal user interaction. If the device is shut off, has a low bandwidth connection, and switches between networks frequently, the download is persistent and resumes as necessary to eventually download the file in its entirety. So, at step 310, the system determines whether the download has been interrupted by network access. If not, after the download is completed, the user is notified by a variety of methods such as a text message, email, or chat notification at 316. If so, at 312, the system determines whether the cellular device been shut off or has a low bandwidth connection. If not, the process ends at 305. If so, at 314, the system switches between networks frequently so that the download is persistent and resumes as necessary to eventually download the file in its entirety. At 316, once the file is downloaded to the cellular device, the user is notified by a variety of methods such as a text message, email, or chat notification and the process ends at 305.

The user can mount the device via USB as a hard drive and access the file. The present invention provides a download scheduling system where the user provides a URL (instead of a file already in their possession). Also, the file is downloaded from the given URL to the device using a file transfer protocol that resumes between network and disconnects automatically. Scheduling of a download without any necessary user interaction with a system that is intelligent enough to handle network disconnects by the cellular device is the novel idea.

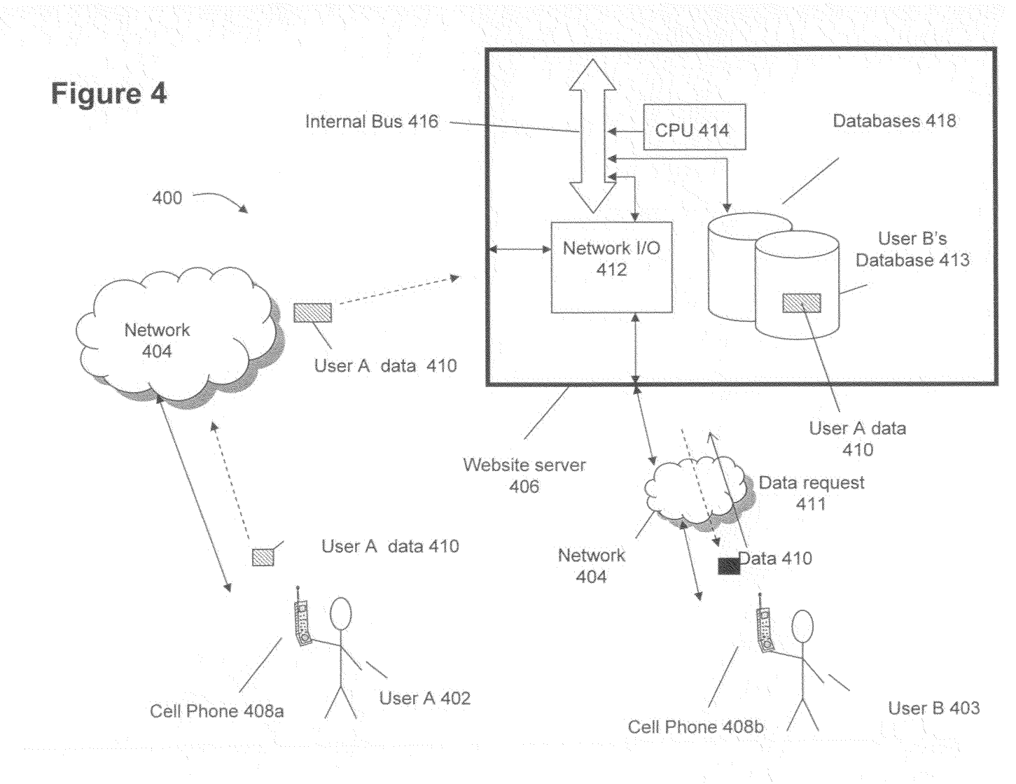

An example embodiment 400 of the implementation is shown in FIG. 4. A Website Server 406 is setup to take user requests (such as Data Request 411), a user account (such as User B's database or account 413) is created for security purposes and the cellular number of her device is associated with the account. When the user (User B 403) logs in, she simply provides a URL of the file she wants downloaded to her device (408b). The Website Server (406) communicates with the Device (408b) at this point to ensure that the Device (408b) has enough space. If the Device (408b) is not currently on the network, the Device (408b) checks later and notifies the user at that point in time if there is not enough space (by email, chat, text message, etc.). The Website Server (406) initiates a file transfer protocol with file resume capability. Most file transfer protocols that support download resuming use sequence numbers to delimitate blocks of data. As part of a header for these blocks of data, the Website Server (406) transmits a checksum in addition to the sequence number to the cellular Device (408b). The Device (408b) validates the checksum when it receives a complete block. If it finds an invalid block, it sends a request to the Website Server (406) for retransmissions. The cellular Device (408b) keeps a transaction log with a name corresponding to the file. The Device (408b) logs the sequence number of each block that it has successfully received. When the Website Server (406) initiates a download, the Device (408b) checks to see if it has a log for the given URL. If there is an existing log for the file, the Device (408b) notifies the Website Server (406) that this is a resume transmission and provides the sequence number of the first block it is missing. When the file is successfully downloaded, the user is notified either by the phone (Device (408b)) or Website Server (406). Here are some examples: the cellular Device (408b) beeps notifying the user (User B 103) that it has downloaded a file. The Website Server (406) sends the user a text message (the user (User B 103) may want to receive notifications on a different cellular device).
1. The Website Server (406) sends an email the cellular Device (408b); and
2. The Website Server (406) leaves a voicemail for the user (User B 103) of the cellular Device (408b) in the user's mailbox (User B's Database 413).

There are three distinct implementations of the present invention which are useful independent of each other:
1. The URL for the file download is queued on the pervasive device (Device (408b)) and the pervasive device (Device (408b)) manages the restartable/reliable download itself;
2. The URL for the file download is queued in a utility application on a personal computer. This is primarily for ease of use as typing a long URL on a personal computer is easier than on a pervasive device (Device (408b)); and
3. The download URL is then transferred to the pervasive device (Device (408b)) via Bluetooth® and its restart/reliable state is managed on the pervasive device as in the URL for the file download is queued on a website as described in the disclosure already. (Bluetooth is an industrial specification for wireless personal area networks (PANs). Bluetooth provides a way to connect and exchange information between devices such as mobile phones, laptops, PCs, printers, digital cameras, and video game consoles over a secure, globally unlicensed short-range radio frequency. The Bluetooth specifications are developed and licensed by the Bluetooth Special Interest Group.).

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to an individual in the art are included within the scope of the invention as defined by the accompanying claims.

1. A method for a user, having a cellular pervasive device having connectivity to a website server, to request and receive asynchronous file downloads to his cellular pervasive device from a website server comprising the steps of:
a. the user logging into the website;
b. the user entering a URL for a file download to his cellular pervasive device from the website; and
c. the website server downloading a file to the user's cellular pervasive device.

2. The method of claim 1 wherein the cellular pervasive device is a cell phone or a PDA.

3. The method of claim 1 wherein if the download has interrupted network access by the cellular device if the initiation of the download is deferred by the server until the device has connectivity.

4. The method of claim 3 further comprising the steps of determining if the cellular device is shut off has a low bandwidth connection, and switching between networks frequently so that the download is persistent and resumes as necessary to eventually download the file in its entirety.

5. The method of claim 1 further comprising the step of, once the file is downloaded, the user is notified by a variety of methods such as a text message, email, or chat notification.

6. The method of claim 5 further comprising the step of the user mounting the device via USB as a hard drive and access the file.

7. A computer program product in a computer readable medium for operating in a system comprising a network I/O, a CPU, one or more databases, connectors for receiving adaptors or other electronic devices, for implementing a method for a user, having a cellular pervasive device having connectivity to a website server, to request and receive asynchronous file downloads to his cellular pervasive device from a website server, the method comprising the steps of:
a. the user logging into the website;
b. the user entering a URL for a file download to his cellular pervasive device from the website; and
c. the website server downloading a file to the user's cellular pervasive device.

8. The computer program product of claim 7 wherein the cellular pervasive device is a cell phone or a PDA.

9. The computer program product of claim 8 wherein the method further comprises the steps of, if the download has interrupted network access by the cellular device, the initiation of the download is deferred by the server until the device has connectivity.

10. The computer program product of claim 9 wherein the method further comprises the steps of determining if the cellular device is shut off has a low bandwidth connection, and switching between networks frequently so that the download is persistent and resumes as necessary to eventually download the file in its entirety.

11. The computer program product of claim 8 wherein the method further comprises the step of, once the file is downloaded, the user is notified by a variety of methods such as a text message, email, or chat notification.

12. The computer program product of claim 11 wherein the method further comprises the step of, once the file is downloaded, notifying the user by a text message, email, or chat notification.

13. The computer program product of claim 12 wherein the method further comprises the step of the user mounting the device via USB as a hard drive and access the file.

14. A method for a user, having a cellular pervasive device having connectivity to a website server, to request and receive asynchronous file downloads to her cellular pervasive device from a website server comprising the steps of:
setting up the website server to take user requests;
creating a user account for security purposes; and
associating the cellular number of her device with the account.

15. The method of claim 14 further comprising the steps of receiving a login request from a user and receiving the URL of the file she wants downloaded to her device.

16. The method of claim 15 further comprising the steps of the website server communicating with the device to ensure that the device has enough space for the file download and, if the device is not currently on the network, the device checking later and notifying the user at that point in time if there is not enough space (by email, chat, text message, etc.).

17. The method of claim 16 further comprising the steps of the website server initiating a file transfer protocol with file resume capability.

18. The method of claim 17 further comprising the steps of the website server transmitting a checksum in addition to the sequence number to the device and the device validating the checksum when it receives a complete block.

19. The method of claim 18 further comprising the steps of, if the cellular device finds an invalid block, sending, from the cellular device, a request to the website server for retransmissions.

20. The method of claim 19 further comprising the steps of the cellular device keeping a transaction log with a name corresponding to the file and the device logging the sequence number of each block that it has successfully received.

21. The method of claim 20 further comprises the steps of the website server initiating a download and the device checking to see if it has a log.
